(19) United States
(12) Patent Application Publication
(10) Pub. No.: US 2004/0251647 A1
(43) Pub. Date: Dec. 16, 2004

(54) Emergency response handcart

(76) Inventor: Keith Graham, Muncie, IN (US)

Correspondence Address: FROST BROWN TODD LLC, 2200 PNC Center, 201 East Fifth Street, Cincinnati, OH, 45202, US

(21) Appl. No.: 10/863,889

(22) Filed: Jun. 8, 2004

Related U.S. Application Data
(60) Provisional application No. 60/477,075, filed on Jun. 9, 2003.

(51) Int. Cl. B62B 3/00

(52) U.S. Cl. 280/47.11

(57) ABSTRACT

A handcart for addressing the specific equipment needs of emergency responders such as fire fighters, police, hazardous material technicians, forensic technicians, explosive ordinance disposal technicians, and others. Differential steering and sizing of a pull handle allow the trailer to fit within a stairwell and an elevator, and allow the handcart to be used in buildings such as by firefighters. An optional pressurized gas bottle rack may be installed by such firefighters to extend their working time in a building fire. Large tires avoid sinking into soft ground. A handbrake automatically keeps the handcart in place on uneven ground. A foldable wash table engageable to a keel drawbar receptacle enables hazardous material decontamination, especially in conjunction with a water reservoir and a splash guard protecting the handcart. For explosive ordinance disposal, a disrupter arm may be mounted to the keel drawbar receptacle, especially with a blast shield attached to the rear of the handcart for personnel protection.

### CROSS REFERENCE TO RELATED APPLICATIONS

The present application hereby claims the benefit of the provisional patent application of the same title, Ser. No. 60/477,075, filed on 9 Jun. 2003.

### TECHNICAL FIELD

The present invention pertains to a trailer, and more particularly to a handcart suited for emergency responders (e.g., fireman, hazardous material technician, explosive ordinance disposal, police, military, forensic technicians, etc.).

### BACKGROUND OF THE INVENTION

Emergency responders are increasingly dependent upon various pieces of equipment to perform their duties. Often, these duties are in areas that are not readily accessible by vehicle, or too hazardous to risk proximity of an expensive vehicle. Examples include an accident site on soft ground, a building fire accessible to firefighters through an elevator or a stairwell, a reported explosive in a subway, etc. Consequently, emergency responders are forced to carry their personal safety equipment and other items necessary for their job to these locations. Making multiple trips is inconvenient and hampers successful accomplishment of their mission.

Consequently, a significant need exists for a way to transport equipment to locations typically accessible only to pedestrians with features that advantageously support the time critical and often dangerous missions performed by emergency responders, such as firemen and explosive ordinance disposal specialists.

### SUMMARY OF THE INVENTION

The present invention addresses these and other problems in the prior art by providing a handcart that carries equipment used by emergency responders which can be taken into spaces such as elevators and stairwells, with features such as differential two-axle steering and an appropriately sized draw bar and trailer frame to fit in these spaces.

These and other objects and advantages of the present invention shall be made apparent from the accompanying drawings and the description thereof.

### BRIEF DESCRIPTION OF THE FIGURES

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a front perspective view of a handcart for emergency response equipment.

FIG. 2 is a rear perspective view of the handcart of FIG. 1.

FIG. 3 is a bottom perspective view of the handcart of FIG. 1 including a differential two-axle steering mechanism.

FIG. 4 is a bottom perspective view of a rear portion of the handcart of FIG. 1 having a disconnected and pinned rear steering section.

FIG. 5 is a rear perspective of the handcart of FIG. 1 with a wheel removed to illustrate elements of a parking brake.

FIG. 6 is a side perspective view of a disrupter arm for explosive ordinance disposal, mountable to a rear attachment of the handcart of FIG. 1.

FIG. 7 is a perspective view of an oxygen tank rack engageable to the handcart of FIG. 1 for firefighter use.

FIG. 8 is a perspective view partially exploded of a foldable wash table, mountable to the rear attachment of the handcart of FIG. 1 for decontamination washing.

FIG. 9 is a perspective view of the handcart of FIG. 1 with wheels removed and a splash shield installed to protect the handcart during use of the foldable wash table.

FIG. 10 is a perspective view of the handcart of FIG. 1 with the wheels removed and a blast resistant shield to protect a user during explosive ordinance disposal.

FIG. 11 is a perspective view of the handcart of FIG. 1 with the oxygen tank rank of FIG. 7 installed.

FIG. 12 is a rear perspective view of the handcart of FIG. 1 with the foldable wash table of FIG. 8 and the splash shield of FIG. 9 installed.

FIG. 13 is a perspective view of the handcart of FIG. 1 with the disrupter arm of FIG. 6 and the blast resistant shield of FIG. 10 installed.

### DETAILED DESCRIPTION OF THE INVENTION

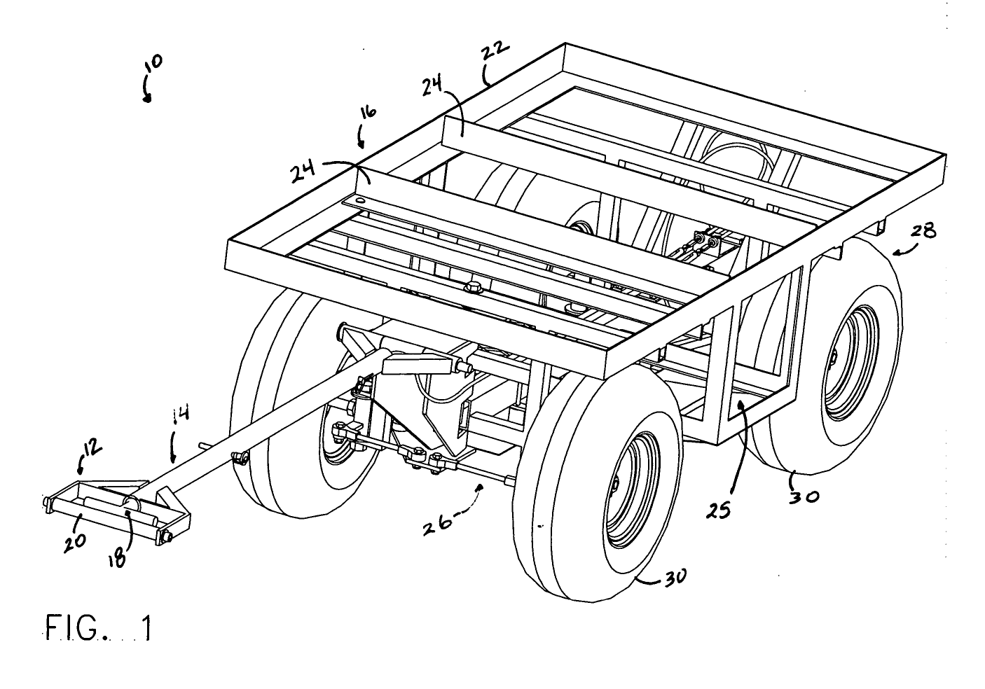

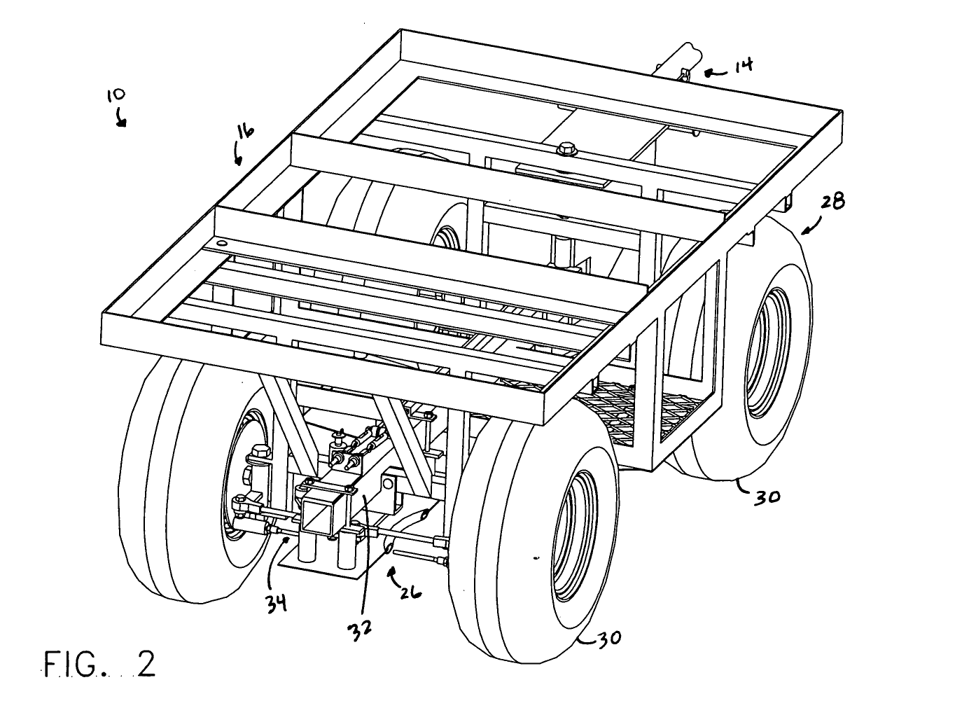

Turning to the Drawings, wherein like numbers refer to like components throughout the several views, FIGS. 1-2 depict a cart 10 that can advantageously be hand drawn by a handle 12 and draw bar 14 coupled to a trailer frame 16, both sized advantageously for being pulled through standard sized doorways, elevators, and building stairwells. The handle 12 includes a brake release 18 squeezed toward a front bar 20 to release the wheel brakes. A spring or gas-charged shock absorber may be advantageously connected to a base of the handle 12 to bias the handle upward for easier grasping, especially by a heavily clothed and equipped emergency responder.

A top frame 22 formed from angled metal bars includes adjustable cross members 24 that may be positioned to fit equipment items. A recessed compartment 25 between a front axle 26 and a rear axle 28 accepts other equipment items. Oversize tires 30 accommodate rough and soft terrain.

In FIG. 2, the cart 10 is shown as including a central open keel 32 that forms an equipment attachment receptacle 34 for receiving emergency response equipment.

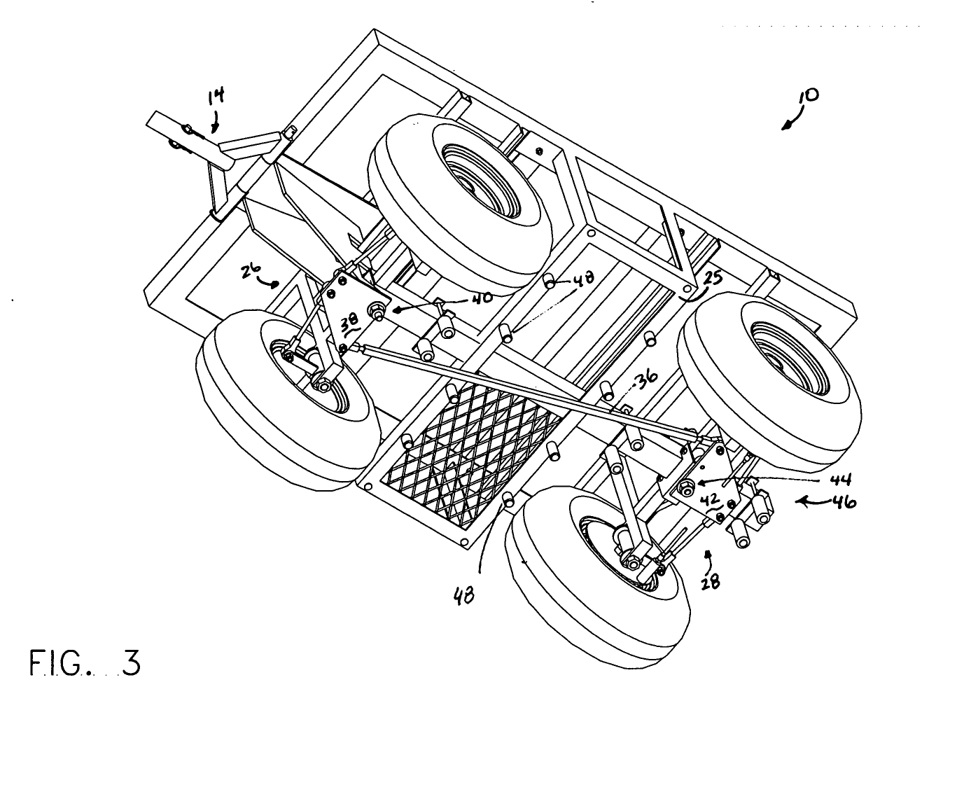

FIG. 3 depicts a pivotal attachment of both the front axle 26 and the rear axle 28, along with a connecting rod 36 offset coupled to a right angled steering plate 38 on a front pivot point 40 of the front axle 26 and to a left angled steering plate 42 on a rear pivot point 44 of the rear axle 28. Thereby, a differential two-axle steering mechanism 46 is formed, achieving a tight turn radius that may be advantageous in moving the cart 10 into an elevator, a stairwell or other similar places. Downward projecting pins 48 attached to the recessed compartment 25 and/or keel 32 provide attachments points spaced away from steering mechanism 46 onto which a splash guard (not shown) may be attached to protect such components.

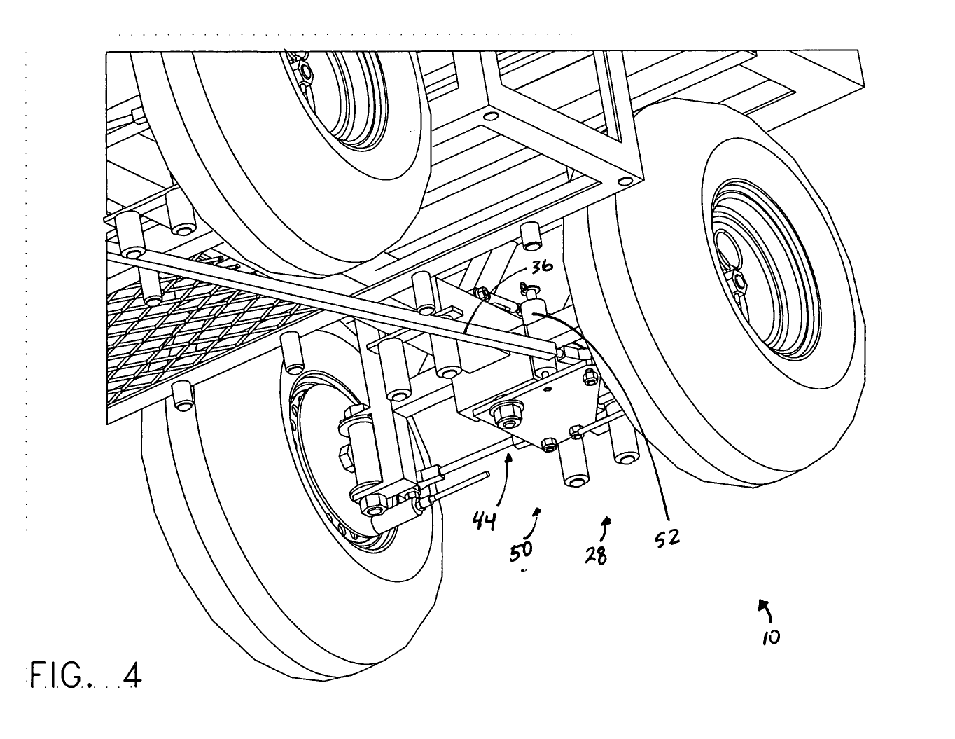

FIG. 4 depicts a rear axle lockup feature 50 that may be used when differential steering is not desired. For example, the connecting rod 36 may have become damaged and disconnected, so a bolt 52 is inserted to lockup the rear pivot point 44. Another instance may be the need to tow the cart 10, such as with an all terrain vehicle, wherein the increased speed may make differentially steering unstable for the cart 10.

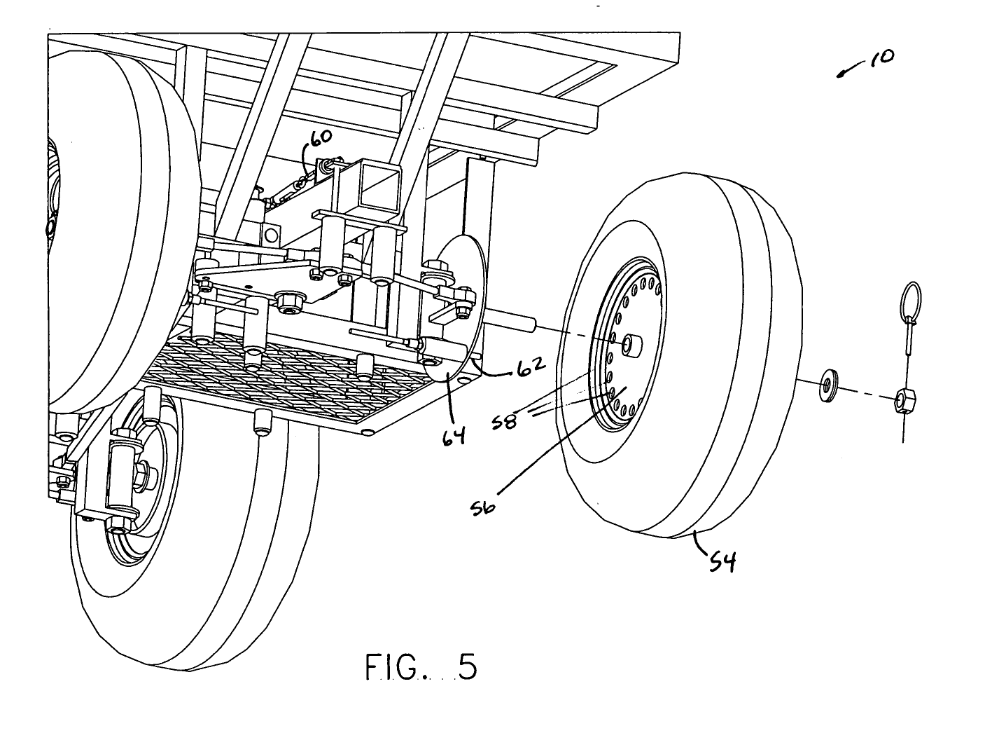

FIG. 5 shows a wheel 54 removed to expose a brake plate 56 having a plurality of parking brake apertures 58. When the brake release 18 is not squeezed, a cable 60 is relaxed, allowing a spring-loaded pin 62 on a brake mounting plate 64 to pass through one of the parking brake apertures 58.

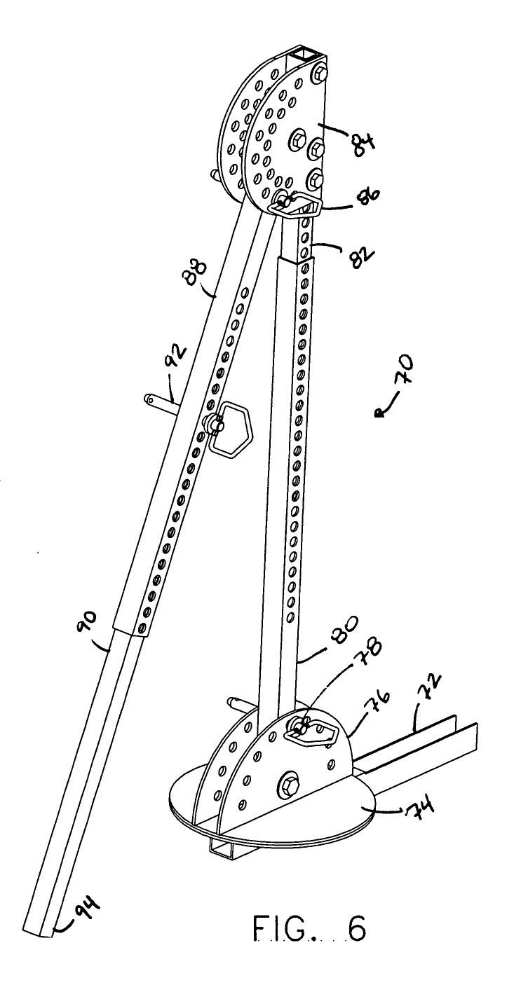

FIG. 6 depicts a disrupter mechanism 70 that has a mounting bar 72 that may be inserted into the equipment attachment receptacle 34 (not depicted in FIG. 6). A horizontal pivot table 74 attached to the mount bar 72 allows the disrupter mechanism 70 to be rotated in azimuth. A vertical 180 degree pivot joint 76 allows a pin 78 to be inserted into a pivoting arm 80 at a desired vertical angle. The pivoting arm 80 includes a telescoping member 82 to increase the height of the pivoting arm 80. Another 180 degree pivot joint 84 fixed with a pin 86 attached to another end of the pivoting arm 80 allows a second arm 88 to be oriented at a desired angle from the first arm 80. Further, the second arm 88 has a telescoping terminal member 90 set a desired length by a pin 92. An explosive ordinance disposal device may then be mounted on a terminal end 94 of the second arm 88.

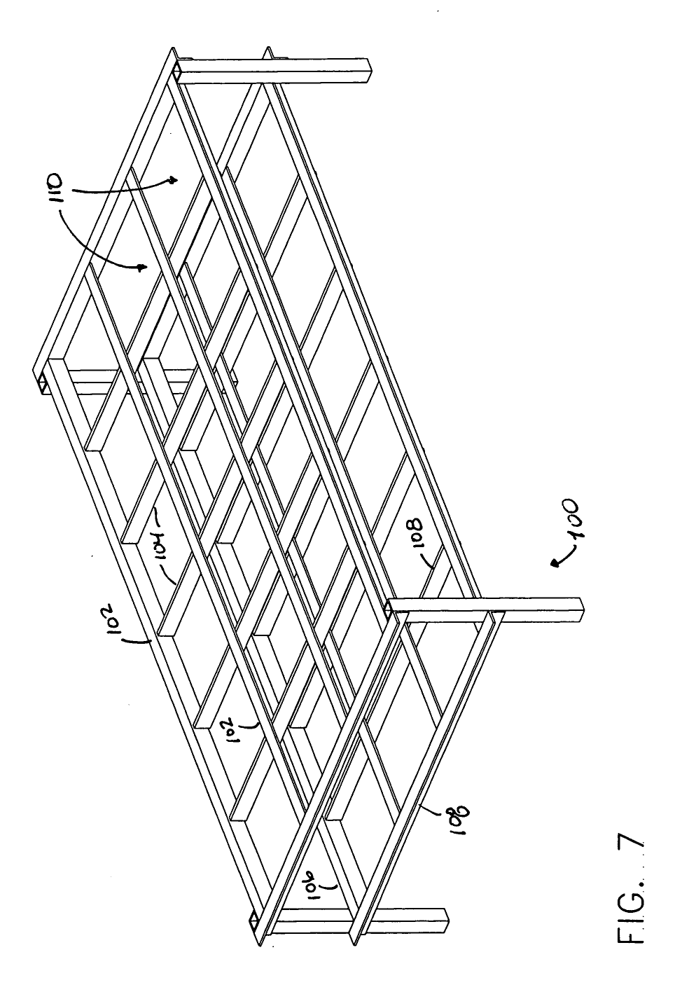

FIG. 7 depicts a rack 100 that includes a series of longitudinal and lateral top cross members 102, 104 and a series of vertically aligned longitudinal and lateral bottom cross members 106, 108 that form passages 110 for holding pressurized gas vessels.

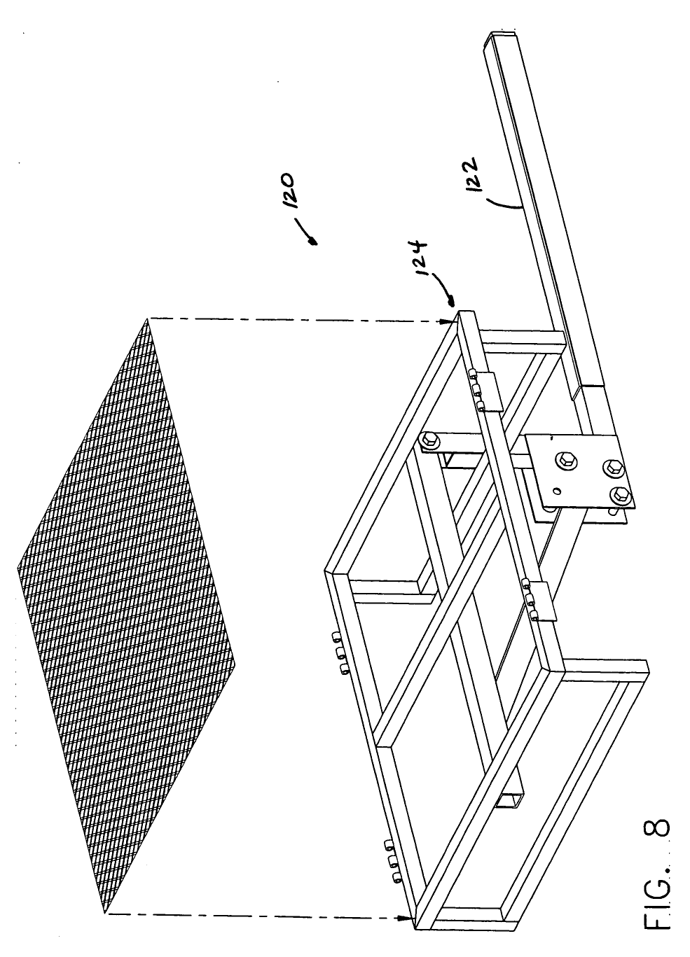

FIG. 8 depicts a wash table 120 that includes a mounting bar 122 attached to a folding frame 124.

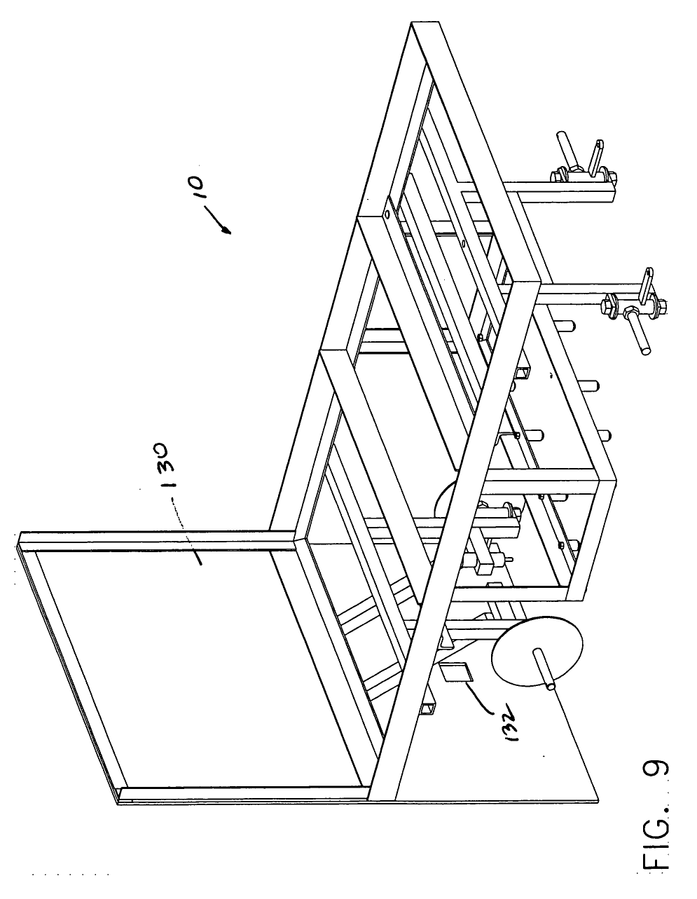

FIG. 9 depicts the cart 10 with a liquid resistant splash shield 130 mounted on the rear of the cart 10, with an aperture 132 positioned for a mounting bar of a rear mounting device to be installed.

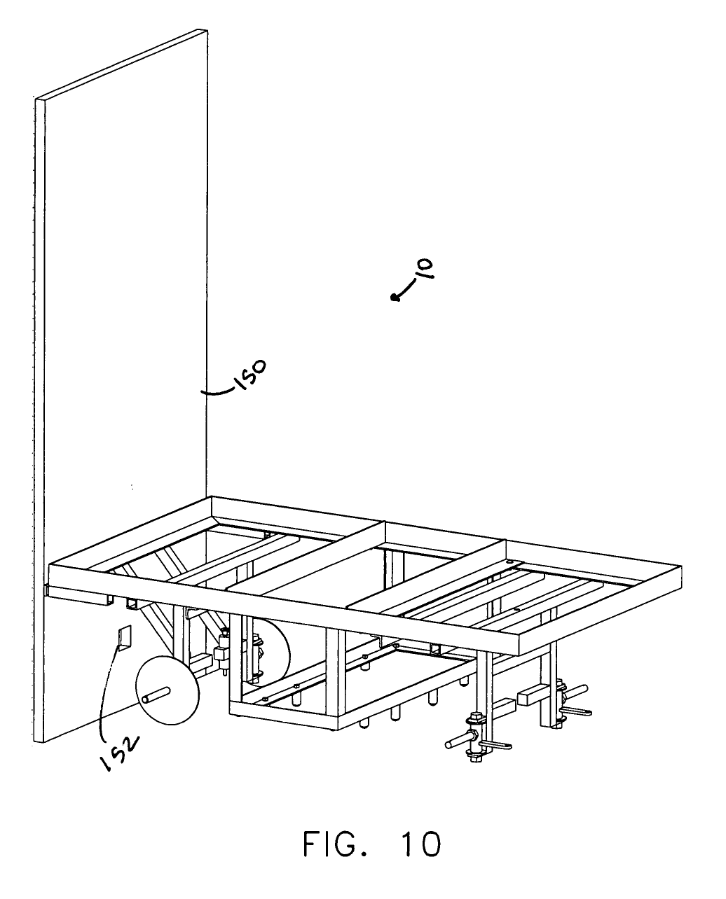

FIG. 10 depicts the cart 10 with a blast resistant shield 150 mounted on the rear of the cart 10, also including an aperture 152 positioned for a mounting bar of a rear mounting device to be installed.

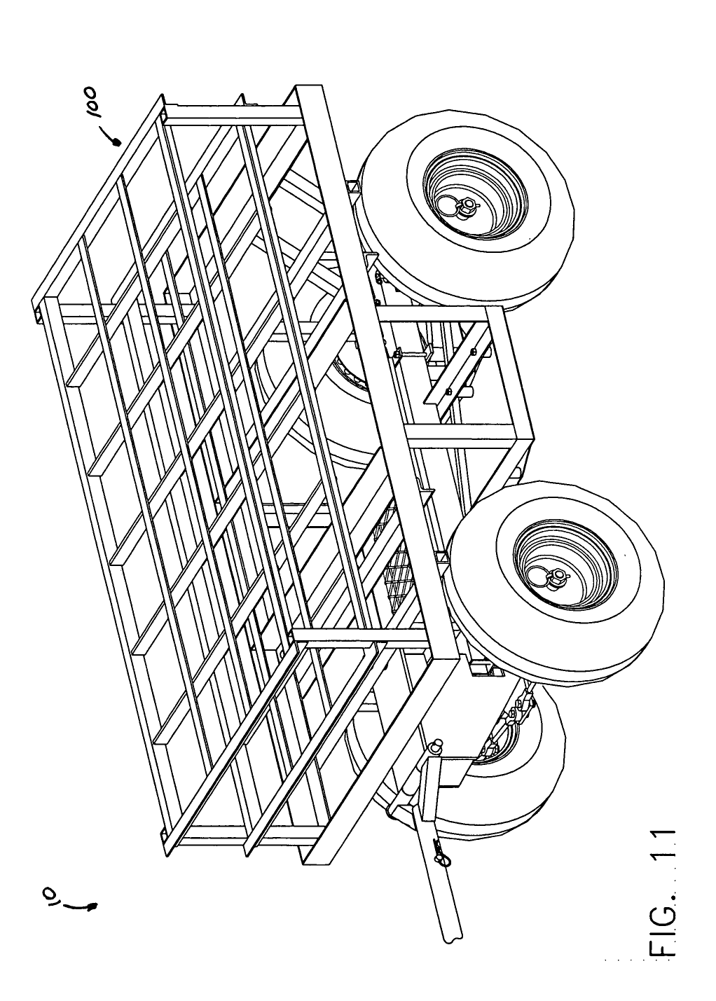

FIG. 11 depicts the cart 10 with the rack 100 of FIG. 7 installed.

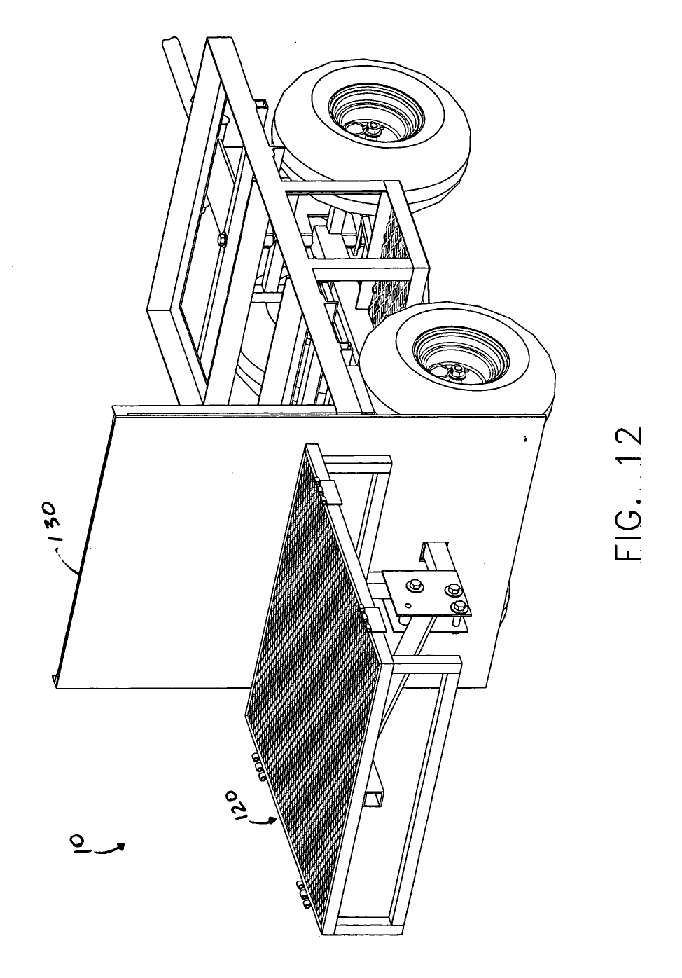

FIG. 12 depicts the cart 10 with the splash shield 130 and wash table 120 installed. Thus, when a wash reservoir is loaded on the cart 10, articles contaminated with hazardous materials may be decontaminated. The splash shield 130 protects the cart 10 and other equipment from any hazardous chemicals.

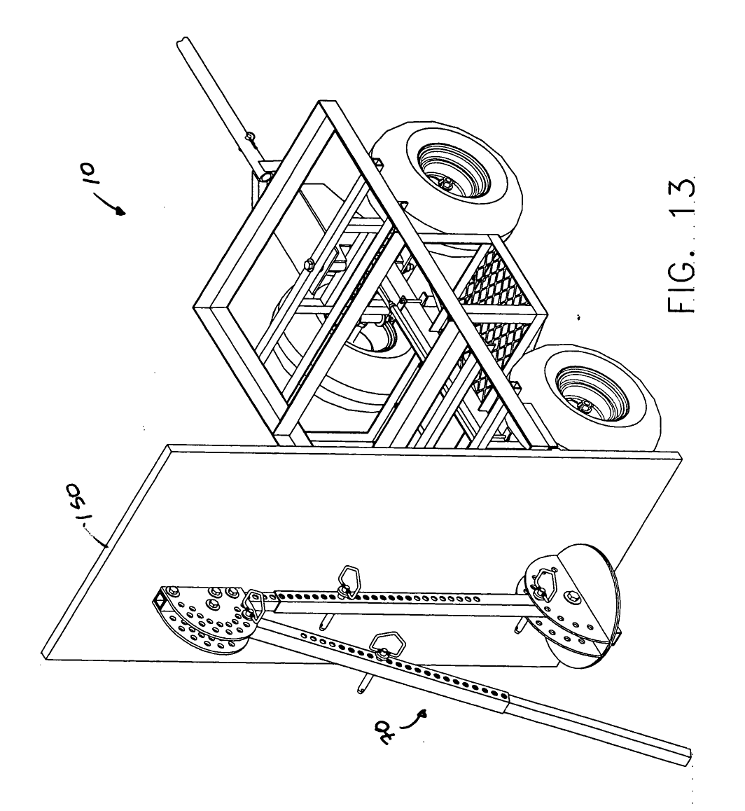

FIG. 13 depicts the cart 10 with the blast resistant shield 150 and with the disrupter mechanism 70 installed for use during explosive ordinance disposal.

While the present invention has been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art.

For example, it should be appreciated that the handcart may be formed from nonferrous material so that it may be used by naval explosive ordinance disposal technicians. Thus, the handcart may be placed proximate to sea mines that are triggered by magnetic detection. In this application, the size of the wheel base of the handcart and the size of the tires may be advantageously increased so that the handcart will be stable and nonsinking on a beach, for instance.

For another example, one or most light posts may be engageable to the trailer bed and powered by an electrical generator or a battery carried by the handcart.

The compact size of the trailer 10 advantageously lends itself to efficient transport upon a rectangular bed with a support structure and attachment for selective engagement to a drawbar fixture at the rear of a truck or other utility vehicle. This support structure may advantageously include hydraulic or electrical controls for raising and lowering the rectangular bed for ease of loading and unloading.

What is claimed is:

1. A cart for emergency responders, comprising:
a trailer frame sized for a pedestrian entrance;
a two-axle, differential steering mechanism supporting the trailer frame; and
a pull handle attached to the steering mechanism.

2. The cart of claim 1, further comprising a wheel brake manually actuated by a user.

3. The cart of claim 1, further comprising a rear attachment member configured for an emergency accessory device.

4. The cart of claim 3, further comprising a wash table attachable to the rear attachment member.

5. The cart of claim 4, further comprising a splash cart separating the wash table from the trailer frame.

6. The cart of claim 3, further comprising an articulating disrupter arm, attachable to the rear attachment member.

7. The cart of claim 6, further comprising a blast shield attachable to a rear portion of the trailer frame.

8. The cart of claim 1, further comprising a rack sized for pressurized gas bottles.

9. The cart of claim 1, further comprising a ground shield underlying the trailer frame positioned to protect the two-axle differential steering mechanism.

10. The cart of claim 1, further comprising a rear axle lockup mechanism for nondifferential steering of a rear axle.

11. The cart of claim 1, wherein the pull handle is vertically pivotally coupled to the two axle differential steering mechanism, the cart further comprising a resilient member operatively coupled between the pull handle and the pivotal coupling thereof to bias the pull handle upward.

12. The cart of claim 1, wherein the trailer frame further comprises:
a horizontal planar surface; and
a plurality of cross members selectively engageable across the horizontal planar surface to define equipment holding spaces.

13. The cart of claim 12, further comprising a recessed compartment defined in the horizontal planar surface sized for vertically elongated equipment items.

14. The cart of claim 1 for supporting explosive ordinance disposal of a magnetically sensitive naval munition, wherein the frame, steering mechanism and drawbar are formed from nonferrous materials, the tires having a footprint suitable for supporting the cart on sand.

15. A handcart for emergency responders, comprising:
a trailer frame;
a two-axle, differential steering mechanism supporting the trailer frame;
a pull handle attached to the steering mechanism; and
a handbrake releasable by an actuator distally presented on the pull handle.

16. A handcart for emergency responders, comprising:
a trailer frame laterally sized for a pedestrian doorway;
a central keel supporting the trailer frame and rearwardly opening to form a drawbar attachment mechanism;
a steering mechanism supporting the trailer frame;
a pull handle attached to the steering mechanism; and
a device having a forwardly projecting drawbar sized for engagement in the drawbar attachment mechanism of the central keel.

17. The handcart of claim 16, wherein the device comprises an articulating disruptor arm.

18. The handcart of claim 17, further comprising a rearwardly mounted blast shield attachable to the trailer frame.

19. The handcart of claim 16, wherein the device comprises a wash table.

20. The handcart of claim 16, further comprising a wheel brake.
